(19) United States
(12) Patent Application Publication
(10) Pub. No.: US 2025/0211346 A1
(43) Pub. Date: Jun. 26, 2025

(54) TERMINAL DEVICE, COMMUNICATION METHOD, AND STORAGE MEDIUM

(71) Applicant: JVCKENWOOD Corporation, Yokohama-shi (JP)

(72) Inventor: Takahiro Mishina, Yokohama-shi (JP)

(21) Appl. No.: 19/074,506

(22) Filed: Mar. 10, 2025

Related U.S. Application Data
(63) Continuation of application No. PCT/JP2023/032359, filed on Sep. 5, 2023.

(30) Foreign Application Priority Data
Sep. 27, 2022 (JP) 2022-153386

(51) Int. Cl. H04B 17/373; H04W 76/19

(52) U.S. Cl. CPC H04B 17/373; H04W 76/19

(57) ABSTRACT

A terminal device includes a communication unit that communicates with a terminal device of a communication partner, a communication quality information generation unit that measures communication quality with a plurality of server devices and generates communication quality information indicating the communication quality, a connection destination specification unit that specifies a second server device different from a first server device that is a current connection target, a connection management unit that controls a communication unit to establish connection to the first server device, a request information transmission unit that controls, in a case of performing communication from a local terminal device to an other terminal device, the communication unit to transmit, to the other terminal device, multi-session request information including connection information to the second server device, and a response information reception unit that controls the communication unit to acquire multi-session response information including connection information between the other terminal device and a third server device from the other terminal device. The connection management unit controls the communication unit to connect the local terminal device with the second server device and the third server device in a case where multi-session response information is acquired.

### CROSS-REFERENCE TO RELATED APPLICATIONS

This application is a Continuation of PCT International Application No. PCT/JP2023/032359 filed on Sep. 5, 2023 which claims the benefit of priority from Japanese Patent Application No. 2022-153386 filed on Sep. 27, 2022, the entire contents of both of which are incorporated herein by reference.

### BACKGROUND OF THE INVENTION

### 1. Field of the Invention

The present disclosure relates to a terminal device, a communication method, and a program.

### 2. Description of the Related Art

A push-to-talk over cellular (PoC) system in which a PoC terminal device and a PoC server device are connected to a wireless network such as long term evolution (LTE) and a wired network such as an optical line is known (see, for example, JP 2018-133796 A).

In the PoC system, it is conceivable to continue a voice call by switching the server device to be connected in a case where the communication quality deteriorates or a delay occurs in the voice call depending on the use environment. However, if the server device to be connected is switched during the voice call, it takes time to connect to a new server device and resume the call, and there is a possibility that the voice is interrupted due to loss of a voice packet, retransmission, or the like.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A terminal device according to the present disclosure comprising: a communication unit that communicates with a terminal device of a communication partner; a communication quality information generation unit that measures communication quality with a plurality of server devices and generates communication quality information indicating the communication quality; a connection destination specification unit that specifies, based on the communication quality information, a second server device different from a first server device that is a current connection target among a plurality of server devices; a connection management unit that controls the communication unit to establish connection to the first server device; a request information transmission unit that controls, in a case of performing communication from a local terminal device to an other terminal device, the communication unit to transmit, to the other terminal device, multi-session request information including connection information to the second server device; and a response information reception unit that controls the communication unit to acquire multi-session response information including connection information between the other terminal device and a third server device from the other terminal device, wherein the connection management unit controls the communication unit to connect the local terminal device with the second server device and the third server device in a case where the response information reception unit acquires multi-session response information.

A communication method according to the present disclosure comprising: a step of measuring communication quality with a plurality of server devices and generating communication quality information indicating the communication quality; a step of specifying, based on the communication quality information, a second server device different from a first server device that is a current connection target among a plurality of server devices; a step of establishing connection to the first server device; a step of, in a case of performing communication from a local terminal device to an other terminal device, transmitting, to the other terminal device, multi-session request information including connection information to the second server device; a step of acquiring and receiving multi-session response information including connection information between the other terminal device and a third server device from the other terminal device; and a step of connecting the local terminal device side with the second server device and the third server device in a case where multi-session response information is acquired in the receiving step.

A non-transitory computer-readable storage medium storing a program causing a computer according to the present disclosure to execute: a step of measuring communication quality with a plurality of server devices and generating communication quality information indicating the communication quality; a step of specifying, based on the communication quality information, a second server device different from a first server device that is a current connection target among a plurality of server devices; a step of establishing connection to the first server device; a step of, in a case of performing communication from a local terminal device to an other terminal device, transmitting, to the other terminal device, multi-session request information including connection information to the second server device; a step of acquiring and receiving multi-session response information including connection information between the other terminal device and a third server device from the other terminal device; and a step of connecting the local terminal device side with the second server device and the third server device in a case where multi-session response information is acquired in the receiving step.

### BRIEF DESCRIPTION OF THE DRAWINGS

FIG. 1 is a diagram illustrating a configuration example of a communication system according to a first embodiment;

FIG. 2 is a block diagram illustrating a configuration example of a terminal device according to the first embodiment;

FIG. 3 is a block diagram illustrating a configuration example of a server device according to the first embodiment;

FIG. 4 is a flowchart illustrating processing content of the terminal device according to the first embodiment;

FIG. 5 is a block diagram illustrating a configuration example of a terminal device according to a second embodiment; and

FIG. 6 is a flowchart illustrating processing content of the terminal device according to the second embodiment.

### DETAILED DESCRIPTION OF THE PREFERRED EMBODIMENTS

Hereinafter, embodiments according to the present disclosure will be described in detail with reference to the accompanying drawings. Note that the present disclosure is not limited by this embodiment, and in the following embodiment, the same parts are denoted by the same reference numerals, and redundant description will be omitted.

### First Embodiment

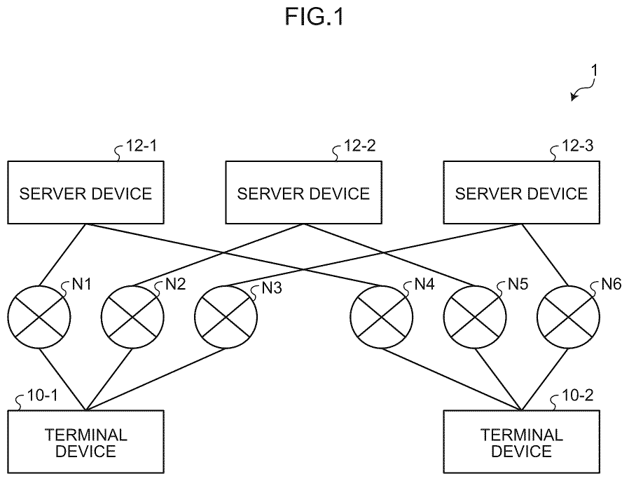

A configuration example of a communication system according to the first embodiment will be described with reference to FIG. 1. FIG. 1 is a diagram illustrating a configuration example of a communication system according to the first embodiment.

As illustrated in FIG. 1, a communication system 1 includes a server device 12-1, a server device 12-2, a server device 12-3, a terminal device 10-1, and a terminal device 10-2. The server devices 12-1 to 12-3 may be collectively referred to as a server device 12. The terminal device 10-1 and the terminal device 10-2 may be collectively referred to as a terminal device 10. The communication system 1 includes three server devices 12, from the server device 12-1 to the server device 12-3, but the present disclosure is not limited thereto. The communication system 1 includes two terminal devices 10, the terminal device 10-1 and the terminal device 10-2, but the present disclosure is not limited thereto.

The server device 12-1 to the server device 12-3 are PoC servers. The terminal device 10-1 and the terminal device 10-2 are PoC terminals. That is, the communication system 1 is a system supporting PoC.

Each of the server devices 12-1 to 12-3 registers the terminal device 10-1 and the terminal device 10-2 as terminal devices included in the communication system 1. The server device 12-1 to the server device 12-3 store the same registration information such as group setting for the terminal device 10-1 and the terminal device 10-2. Each of the server devices 12-1 to 12-3 does not communicate with other server devices 12 each other. The server devices 12-1 to 12-3 can specify the terminal device 10 performing communication.

The terminal device 10-1 is connected to the server device 12-1 via a network N1. The terminal device 10-1 is connected to the server device 12-2 via a network N2. The terminal device 10-1 is connected to the server device 12-3 via a network N3. That is, the terminal device 10-1 is connected to the server devices 12-1 to 12-3 via different networks. The terminal device 10-1 can maintain a communication session with each of the server devices 12-1 to 12-3.

The terminal device 10-2 is connected to the server device 12-1 via a network N4. The terminal device 10-2 is connected to the server device 12-2 via a network N5. The terminal device 10-3 is connected to the server device 12-3 via a network N6. That is, the terminal device 10-2 is connected to the server devices 12-1 to 12-3 via different networks. The terminal device 10-2 can maintain a communication session with each of the server devices 12-1 to 12-3.

The networks N1 to N6 are networks including a wireless network and a wired network. In a case where it is not necessary to distinguish among the networks N1 to N6, the network may be collectively referred to as a network N. Here, in the network connection between the terminal devices 10-1 or 10-2 and the server device 12, it is desirable that the networks N1 to N6 establish communication sessions as different communication connections and communication paths each other. The different communication connections and communication paths are preferably based on physically different communication paths, logically different communication paths, different communication schemes, different frequencies, and different time slots. The terminal device 10-1 and the terminal device 10-2 may be connected to a plurality of such different networks to enable multi-session connection.

In the communication system 1, the terminal device 10-1 and the terminal device 10-2 share information on a plurality of server devices 12 that can be connected to each other. The communication system 1 establishes multi-session connection to the server device 12 at the time of a plurality of common connections between the terminal device 10-1 and the terminal device 10-2.

### Terminal Device

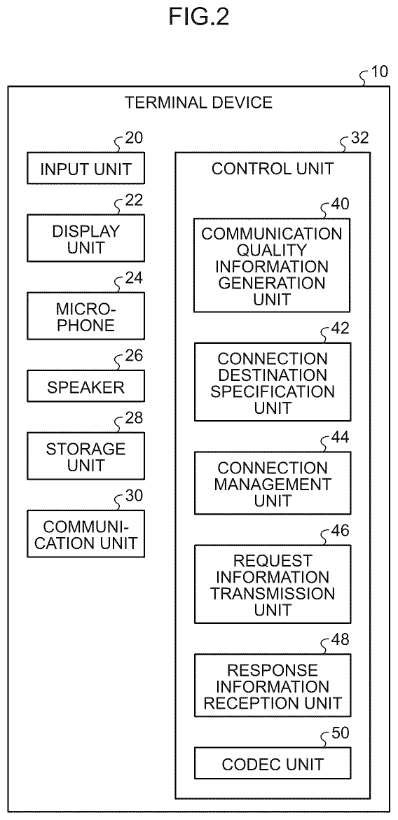

A configuration example of a terminal device according to the first embodiment will be described with reference to FIG. 2. FIG. 2 is a block diagram illustrating a configuration example of the terminal device according to the first embodiment.

As illustrated in FIG. 2, the terminal device 10 includes an input unit 20, a display unit 22, a microphone 24, a speaker 26, a storage unit 28, a communication unit 30, and a control unit 32.

The input unit 20 receives various input operations to the terminal device 10. The input unit 20 outputs an operation signal corresponding to the received input operation to the control unit 32. The input unit 20 includes, for example, a touch panel, a button, a switch, a push-to-talk (PTT) button, and the like. In a case where a touch panel is used as the input unit 20, the input unit 20 is arranged on the display unit 22.

The display unit 22 displays various videos. The display unit 22 is a display including, for example, a liquid crystal display, organic electro-luminescence (EL), and the like.

The microphone 24 is a microphone that detects a voice around the terminal device 10. The microphone 24 detects the voice of a user who uses the terminal device 10. The microphone 24 converts the detected voice into an audio signal.

The speaker 26 is a speaker that outputs various sounds.

The storage unit 28 stores various types of information. The storage unit 28 stores information such as calculation content of the control unit 32 and a program. The storage unit 28 includes, for example, at least one of a random access memory (RAM), a main storage device such as a read only memory (ROM), and an external storage device such as a hard disk drive (HDD).

The communication unit 30 is a communication interface that executes communication between the terminal device 10 and an external device. The communication unit 30 executes communication between the terminal device 10 and the server device 12.

The control unit 32 controls each unit of the terminal device 10. The control unit 32 includes, for example, an information processing device such as a central processing unit (CPU) or a micro processing unit (MPU), and a storage device such as a random access memory (RAM) or a read only memory (ROM). The control unit 32 executes a program for controlling the operation of the terminal device 10 according to the present disclosure. The control unit 32 may be realized by, for example, an integrated circuit such as an application specific integrated circuit (ASIC) or a field programmable gate array (FPGA). The control unit 32 may be realized by a combination of hardware and software.

The control unit 32 includes a communication quality information generation unit 40, a connection destination specification unit 42, a connection management unit 44, a request information transmission unit 46, a response information reception unit 48, and a codec unit 50.

The communication quality information generation unit 40 measures the communication quality indicating the quality of the communication state between the terminal device 10 and the plurality of server devices 12. The communication quality information generation unit 40 can measure a bit rate as the communication quality, for example, but is not limited thereto. For example, a delay amount of communication between the terminal device 10 and the plurality of server devices 12 may be measured as the communication quality. A known method can be used as a method for measuring the communication quality, and is not limited. The communication quality information generation unit 40 generates communication quality information indicating the measured communication quality.

The connection destination specification unit 42 specifies the server device 12 that can be a candidate for the communication destination of the terminal device 10. Specifically, the connection destination specification unit 42 specifies the server device 12 that is different from the server device 12 that is the current connection target and is a candidate for a connection destination on the basis of the communication quality information generated by the communication quality information generation unit 40. The server device 12 to which the terminal device 10 is currently connected to is also referred to as a first server device. The server device 12 that is a candidate for the communication destination of the terminal device 10 is also referred to as a second server device.

The connection management unit 44 establishes connection with a plurality of server devices 12 included in the communication system 1. Specifically, the connection management unit 44 establishes connection with the plurality of server devices 12 by requesting the plurality of server devices 12 for registration.

The connection management unit 44 connects at least one server device 12 of the server device 12 that is a candidate for a connection destination of the terminal device 10 and the server device 12 that is a candidate for a connection destination of another terminal device 10 as a server device 12 common to the terminal device 10 and another terminal device 10.

At a time point at which communication with another terminal device 10 is started or at a time point at which another terminal device 10 is specified, the request information transmission unit 46 transmits multi-session request information including connection information to the server device 12 that is a candidate for a connection destination to another terminal device 10. The connection information to the server device 12 includes information indicating that connection to the server device 12 is possible.

The response information reception unit 48 receives multi-session response information for the multi-session request information including connection information to the server device 12 that is a candidate for a connection destination of another terminal device 10 from another terminal device 10.

The codec unit 50 compresses, for example, the audio information to be transmitted to the server device 12 by an arbitrary compression method. The codec unit 50 decodes, for example, the audio information received from the server device 12.

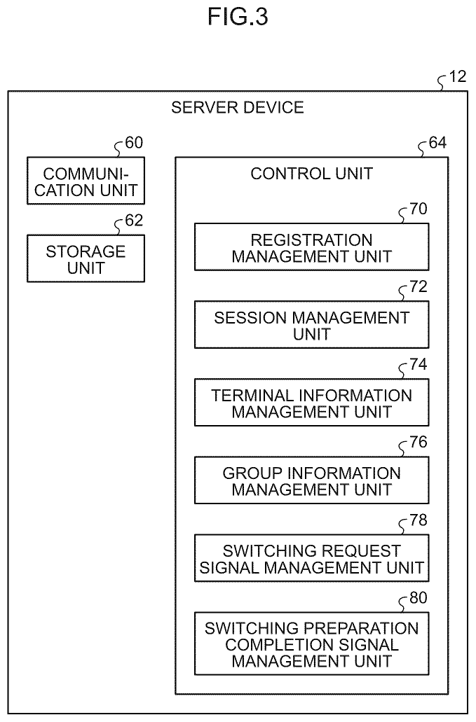

A configuration example of a server device according to the first embodiment will be described with reference to FIG. 3. FIG. 3 is a block diagram illustrating a configuration example of the server device according to the first embodiment.

As illustrated in FIG. 3, the server device 12 includes a communication unit 60, a storage unit 62, and a control unit 64.

The communication unit 60 is a communication interface that executes communication between the server device 12 and an external device. The communication unit 60 executes communication between the server device 12 and the terminal device 10.

The storage unit 62 stores various types of information. The storage unit 62 stores information such as calculation content of the control unit 64 and a program. The storage unit 62 includes, for example, at least one of a RAM, a main storage device such as a ROM, and an external storage device such as an HDD.

The control unit 64 controls each unit of the server device 12. The control unit 64 includes, for example, an information processing device such as a CPU or an MPU, and a storage device such as a RAM or a ROM. The control unit 64 executes a program for controlling the operation of the server device 12 according to the present disclosure. The control unit 64 may be realized by, for example, an integrated circuit such as an ASIC or an FPGA. The control unit 64 may be realized by a combination of hardware and software.

The control unit 64 includes a registration management unit 70, a session management unit 72, a terminal information management unit 74, a group information management unit 76, a switching request signal management unit 78, and a switching preparation completion signal management unit 80.

The registration management unit 70 receives registration from each terminal device 10. The registration management unit 70 registers the terminal device 10 that has received the registration as the communicable terminal device 10.

The session management unit 72 manages a communication session with the terminal device 10. For example, the session management unit 72 transmits audio information received from the terminal device 10 to another terminal device 10 as audio information.

The terminal information management unit 74 causes the storage unit 62 to store various types of information regarding the terminal device 10 that has received the registration.

The group information management unit 76 manages the group information regarding the group to which the terminal device 10 belongs stored in the storage unit 62.

The switching request signal management unit 78 manages the switching request signal received from the terminal device 10. The switching request signal management unit 78 transmits the switching request signal received from the terminal device 10 to another terminal device 10.

The switching preparation completion signal management unit 80 manages the switching preparation completion signal. The switching preparation completion signal management unit 80 transmits the switching preparation completion signal received from the terminal device 10 on the reception side to the terminal device 10 on the transmission side.

### Processing Content

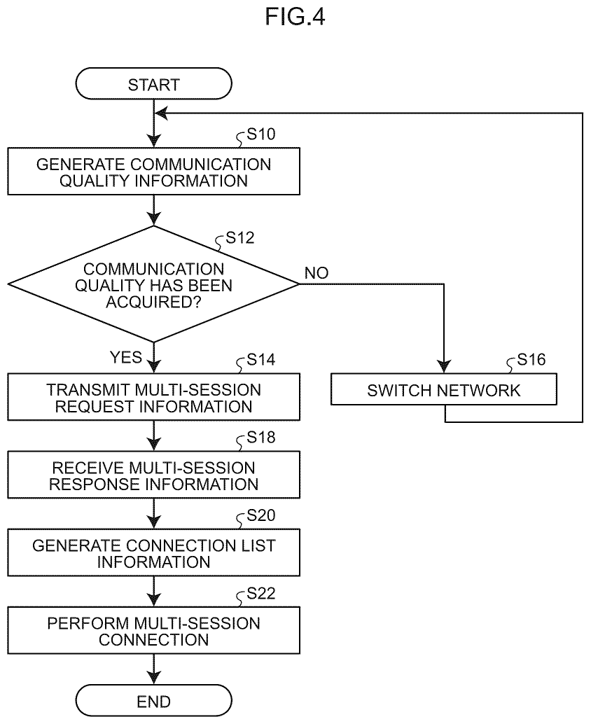

Processing content of the terminal device according to the first embodiment will be described with reference to FIG. 4. FIG. 4 is a flowchart illustrating processing content of the terminal device according to the first embodiment.

Hereinafter, in the example illustrated in FIG. 1, it is assumed that the terminal device 10-1 is the terminal device 10 on the transmission side, and the terminal device 10-2 is the terminal device 10 on the reception side. The processing illustrated in FIG. 4 indicates processing in a case where the number of multi-session connections is not limited in both the terminal device 10-1 and the terminal device 10-2.

The communication quality information generation unit 40 of the terminal device 10-1 generates communication quality information indicating the communication quality with each of the server devices 12 (step S10). Specifically, the communication quality information generation unit 40 of the terminal device 10-1 measures the communication quality with each server device 12 and generates the communication quality information. Then, the process proceeds to step S12.

The connection destination specification unit 42 of the terminal device 10-1 determines whether or not the communication quality of the communication between the terminal device 10-1 and the server device 12 for the multi-session of the terminal device 10-1 has all been acquired (step S12). Specifically, the connection destination specification unit 42 of the terminal device 10-1 determines whether or not the communication quality of communication with the server device 12 that is a candidate for a connection destination has been acquired. If it is determined that all the communication quality with the server device 12 for the multi-session has been acquired (step S12; Yes), the process proceeds to step S14. If it is not determined that all the communication quality with the server device 12 for the multi-session has been acquired (step S12; No), the process proceeds to step S16.

If it is determined as Yes in step S12, the request information transmission unit 46 of the terminal device 10-1 transmits the multi-session request information including the connection information to the server device 12 to another terminal device 10 (step S14). Then, the process proceeds to step S18.

If it is determined as No in step S12, the connection management unit 44 of the terminal device 10-1 switches the network N to be connected from the network N connected to the current server device 12 to the next network N from which the communication quality has not been acquired (step S16). Then, the process proceeds to step S10.

The response information reception unit 48 of the terminal device 10-1 receives the multi-session response information including connection information to the server device 12 that is a candidate for a connection destination of the terminal device 10-2 from the terminal device 10-2 (step S18). Then, the process proceeds to step S20.

The connection management unit 44 of the terminal device 10-1 generates connection list information (step S20). Specifically, the connection management unit 44 of the terminal device 10-1 integrates the connection information of the terminal device 10-1 and the connection information of the terminal device 10-2 to generate connection list information. The connection list information includes information on the server device 12 to which the terminal device 10-1 and the terminal device 10-2 are commonly connected. Then, the process proceeds to step S22.

The connection management unit 44 of the terminal device 10-1 performs multi-session connection with each server device 12 on the basis of the generated connection list information (step S22). Then, the processing of FIG. 4 is ended.

As described above, in the first embodiment, in a case where there is no upper limit to the number of multi-sessions, multi-session connection is performed with the server device 12 included in the connection information of each of the terminal device 10 on the transmission side and the terminal device 10 on the reception side as a common connection destination. As a result, in the first embodiment, when a call is started between the terminal devices 10, even if the server device 12 to be connected is switched, the voice can be prevented from being interrupted, and the server device can be easily switched.

### Second Embodiment

### Terminal Device

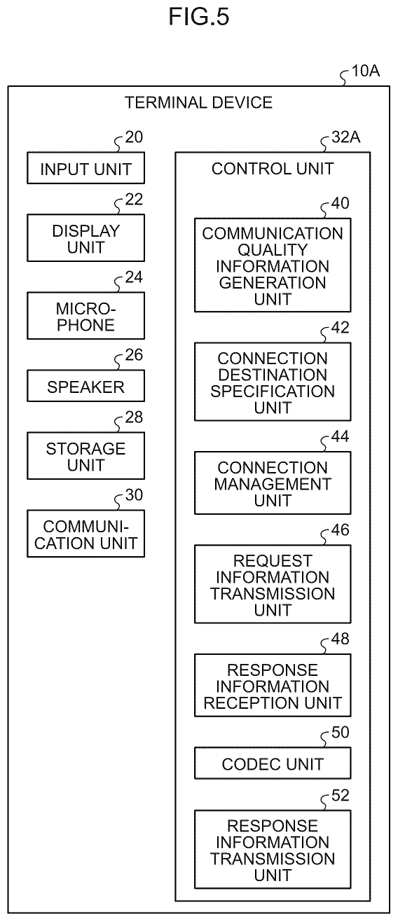

A configuration example of a terminal device according to the second embodiment will be described with reference to FIG. 5. FIG. 5 is a block diagram illustrating a configuration example of the terminal device according to the second embodiment.

As illustrated in FIG. 5, a terminal device 10A is different from the terminal device 10 illustrated in FIG. 2 in that a control unit 32A includes a response information transmission unit 52.

The response information transmission unit 52 transmits multi-session response information to another terminal device 10. Specifically, the response information transmission unit 52 transmits the multi-session response information including the number of connections to the server device 12 and including a connection priority order.

### Processing Content

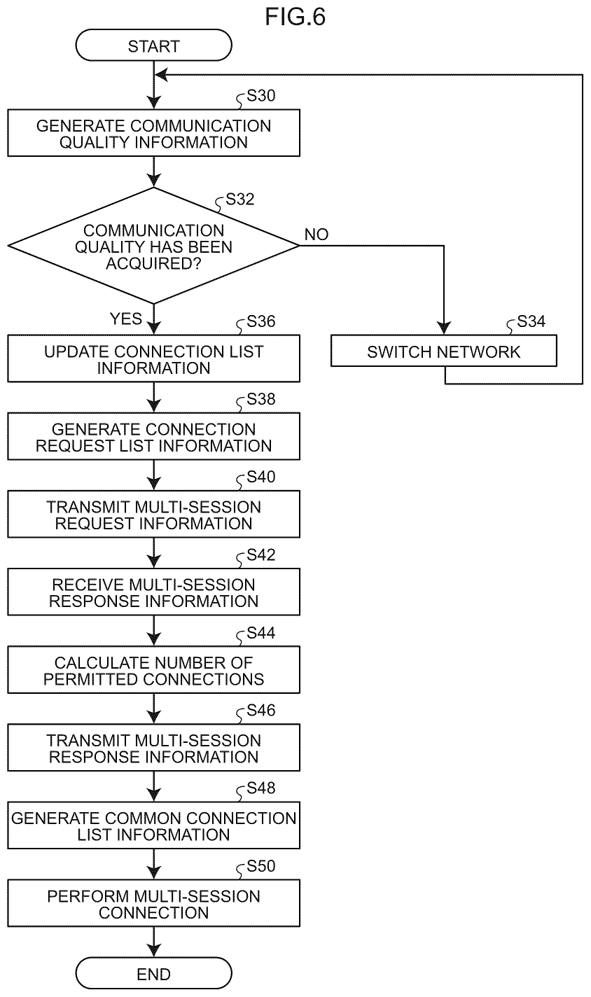

Processing content of the terminal device according to the second embodiment will be described with reference to FIG. 6. FIG. 6 is a flowchart illustrating processing content of the terminal device according to the second embodiment.

The processing illustrated in FIG. 6 indicates processing in a case where the number of multi-session connections is limited in both the terminal device 10-1 and the terminal device 10-2.

Since the processing from step S30 to step S34 is the same as the processing from step S10, step S12, and step S16 illustrated in FIG. 4, the description thereof is omitted.

If it is determined as Yes in step S32, the connection management unit 44 updates the connection list information (step S36). Specifically, for example, the connection management unit 44 updates the connection list information on the basis of the connection information of the server device 12 and the communication quality information such that the server device 12 with better communication quality has a higher priority as a connection target. Then, the process proceeds to step S38.

The connection management unit 44 of the terminal device 10-1 generates connection request list information (step S38). Specifically, the connection management unit 44 of the terminal device 10-1 generates the connection request list information on the basis of the connection list information and the number of connection requests indicating the number of requests of the server device 12 to be connected. The number of connection requests is set to be equal to or less than the upper limit number of multi-session connections. Then, the process proceeds to step S40.

The request information transmission unit 46 of the terminal device 10-1 transmits the multi-session request information to the terminal device 10-2 (step S40). Specifically, the request information transmission unit 46 of the terminal device 10-1 of the terminal device 10-1 transmits the multi-session request information including the connection request information list of the terminal device 10 to another terminal device 10. Then, the process proceeds to step S42.

The response information reception unit 48 of the terminal device 10-1 receives the multi-session response information from the terminal device 10-2 (step S42). Specifically, the response information reception unit 48 of the terminal device 10-1 receives the multi-session response information including the number of permitted connections of the terminal device 10-2 to the server device 12 and the connection request list information from the terminal device 10-2. Then, the process proceeds to step S44.

The connection management unit 44 of the terminal device 10-1 calculates the number of permitted connections of the server device 12 of the terminal device 10-1 (step S44). Specifically, the connection management unit 44 of the terminal device 10-1 calculates the number of permitted connections from the number of connectable sessions. Then, the process proceeds to step S46.

The response information transmission unit 52 of the terminal device 10-1 transmits the multi-session response information including the number of permitted connections of the terminal device 10-1 to the terminal device 10-2 (step S46). Then, the process proceeds to step S48.

The connection management unit 44 of the terminal device 10-1 generates connection list information common to the terminal device 10-1 and the terminal device 10-2 (step S48). Specifically, the connection management unit 44 of the terminal device 10-1 generates the common connection list information on the basis of the number of permitted connections of the terminal device 10-1 and the number of permitted connections of the terminal device 10-2. Then, the process proceeds to step S50.

The connection management unit 44 of the terminal device 10-1 performs multi-session connection with each server device 12 on the basis of the generated common connection list information (step S50). Then, the processing of FIG. 6 is ended.

As described above, in the second embodiment, in a case where there is an upper limit to the number of multi-sessions, the terminal device 10 on the transmission side and the terminal device 10 on the reception side are prioritized to perform multi-session connection on the basis of the number of permitted connections. As a result, in the second embodiment, when a call is started between the terminal devices 10, even if the server device 12 to be connected is switched, the voice can be prevented from being interrupted, and the server device can be easily switched.

Each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like. Note that this configuration by distribution and integration may be performed dynamically.

According to the present disclosure, it is possible to easily switch the server device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal device comprising:
a communication unit that communicates with a terminal device of a communication partner;
a communication quality information generation unit that measures communication quality with a plurality of server devices and generates communication quality information indicating the communication quality;
a connection destination specification unit that specifies, based on the communication quality information, a second server device different from a first server device that is a current connection target among a plurality of server devices;
a connection management unit that controls the communication unit to establish connection to the first server device;
a request information transmission unit that controls, in a case of performing communication from a local terminal device to an other terminal device, the communication unit to transmit, to the other terminal device, multi-session request information including connection information to the second server device; and
a response information reception unit that controls the communication unit to acquire multi-session response information including connection information between the other terminal device and a third server device from the other terminal device, wherein
the connection management unit controls the communication unit to connect the local terminal device with the second server device and the third server device in a case where the response information reception unit acquires multi-session response information.

2. A communication method comprising:
a step of measuring communication quality with a plurality of server devices and generating communication quality information indicating the communication quality;
a step of specifying, based on the communication quality information, a second server device different from a first server device that is a current connection target among a plurality of server devices;
a step of establishing connection to the first server device;
a step of, in a case of performing communication from a local terminal device to an other terminal device, transmitting, to the other terminal device, multi-session request information including connection information to the second server device;
a step of acquiring and receiving multi-session response information including connection information between the other terminal device and a third server device from the other terminal device; and
a step of connecting the local terminal device side with the second server device and the third server device in a case where multi-session response information is acquired in the receiving step.

3. A non-transitory computer-readable storage medium storing a program causing a computer to execute:
a step of measuring communication quality with a plurality of server devices and generating communication quality information indicating the communication quality;
a step of specifying, based on the communication quality information, a second server device different from a first server device that is a current connection target among a plurality of server devices;
a step of establishing connection to the first server device;
a step of, in a case of performing communication from a local terminal device to an other terminal device, transmitting, to the other terminal device, multi-session request information including connection information to the second server device;
a step of acquiring and receiving multi-session response information including connection information between the other terminal device and a third server device from the other terminal device; and
a step of connecting the local terminal device side with the second server device and the third server device in a case where multi-session response information is acquired in the receiving step.
